(19) United States
(12) Patent Application Publication
(10) Pub. No.: US 2019/0375883 A1
(43) Pub. Date: Dec. 12, 2019

(54) SKIN MATERIAL FOR COATING MOTOR VEHICLES PARTS

(71) Applicant: SOLVAY SPECIALTY POLYMERS ITALY S.P.A., Bollate (IT)

(72) Inventors: Antonio RUSSO, Milano (IT); Lionel DE BEAUFFORT, Tervuren (BE)

(21) Appl. No.: 16/331,874

(22) PCT Filed: Sep. 8, 2017
(86) PCT No.: PCT/EP2017/072536

§ 371 Date: Mar. 8, 2019

(30) Foreign Application Priority Data
Sep. 9, 2016 (EP) 16187962.2

(51) Int. Cl. C08G 18/76; C09D 175/08; C08G 18/42; C08G 18/48; C08G 18/44; C08G 18/50; C08G 18/32; C08G 18/66; C08G 18/73; C08G 18/22; C08J 5/18

(52) U.S. Cl. CPC C08G 18/7671; C09D 175/08; C08G 18/4277; C08G 18/4854; C08G 18/44; C08G 18/42; C08J 2375/08; C08G 18/3206; C08G 18/6674; C08G 18/73; C08G 18/227; C08J 5/18; C08G 18/5015

(57) ABSTRACT

The present invention relates to a skin material, which is in the form of a flexible film obtained from a composition comprising at least one fluorinated polymer, and its use for coating motor vehicle parts.

### CROSS REFERENCE TO RELATED APPLICATIONS

This application claims priority from European application No. 16187962.2 filed on 9 Sep. 2016, the whole content of this application being incorporated herein by reference for all purposes.

### TECHNICAL FIELD

The present invention relates to a skin material, which is in the form of a flexible film obtained from a composition comprising at least one fluorinated polymer, and its use for coating motor vehicle parts.

### BACKGROUND ART

In the technical field of manufacturing motor vehicle instruments panels, it is known to provide on the outer surface a film, often referred to as a “skin” or “skin layer”, that gives the external appearance, e.g. the colour, the pattern, the pleasant feel and soft touch. Typically, said skin is joined to the surface of a resin base obtained by injection moulding.

In addition, said skin is used in order to provide good performances in terms of heat ageing resistance, UV resistance, scratch resistance and so on. For example, dashboards are extremely prone to damage from heat and sunrays, intensified by the convex glass in the windshield, which cause warping, cracking and fading of the dashboard.

Conventionally, the main materials used are polyvinyl chloride (PVC) thermoplastic resins, hydrogenated thermoplastic polyurethanes (H-TPU), thermoplastic polyolefins (TPO) and polyurethanes (PU).

Plastic skins as lining materials for automotive applications and methods for the production thereof have been disclosed for example in U.S. Pat. No. 5,013,508 Jul. 5, 1991, US 2009/0062454 (ARKEMA FRANCE), US 2011/0183143 (ARKEMA FRANCE) and US 2012/0076998 (JOHNSON CONTROLS INTERIORS GMBH & CO. KG)

Hydrogenated thermoplastic polyurethane polymers (TPU) have been disclosed to provide said skin, for example in US 2002/0099162 (INOUE MTP KK), US 2006/0287419 (HOSUNG CHEMEX CO LTD) and US 2009/0256276 (INTERNATIONAL AUTOMOTIVE COMPONENTS GROUP NORTH AMERICA, INC.).

Elastomeric polyurethanes comprising (per)fluoropoly-ether blocks have been disclosed for example in U.S. Pat. No. 5,332,798 (AUSIMONT S.P.A.), U.S. Pat. No. 5,043,410 (AUSIMONT S.R.L.), US 20030139540 (AUSIMONT S.R.L.), EP 1864685 A (SOLVAY SOLEXIS S.P.A.) EP 0359273 A (AUSIMONT S.R.L.), US 20150322313 (SOLVAY SPECIALTY POLYMERS ITALY S.P.A.), U.S. Pat. No. 5,189,135 (SYREMONT S.P.A.), U.S. Pat. No. 5,026,814 (AUSIMONT S.R.L.). Liquid compositions for modifications of surfaces have been disclosed for examples in U.S. Pat. No. 7,015,278 (SOLVAY SOLEXIS S.P.A.) and US 20140364542 (AXALTA COATING SYSTEM IP CO., LLC.).

### SUMMARY OF INVENTION

The Applicant perceived the need of providing a polymeric material useful for the manufacture of flexible films to be used as skin layer, notably for coating the interior and/or exterior parts of motor vehicles, such that the skin layer is characterized by improved properties when compared to hydrogenated thermoplastic polyurethane polymers (H-TPU), notably ease of cleanability, improved resistance to stain and finger-prints, chemical and wear resistance, low temperature flexibility, silky feel and mechanical properties.

Thus, in a first aspect, the present invention relates to a flexible film obtained from a composition [composition (C)] comprising at least one fluorinated polyurethane [F-TPU polymer] and optionally further ingredients, said F-TPU polymer comprising recurring units derived from: optionally [monomer (a)] at least one diol selected from the group comprising poly-ether type diol, poly-ester type diol, polybutadien-diol and polycarbonate-diol;
[monomer (b)] at least one hydroxy-terminated (per)fluoropolyether polymer [PFPE polymer];
[monomer (c)] at least one aromatic, aliphatic or cycloaliphatic diisocyanate; and
[monomer (d)] at least one aliphatic, cycloaliphatic or aromatic diol having from 1 to 14 carbon atoms.

The Applicant has surprisingly found that the flexible film obtained from said composition (C) show a soft silky feeling to the touch, without the addition of plasticizer agents to said composition (C). This provides an advantage from the visual point of view, as the plasticizers can migrate on the surface of the film causing undesired changes in the colour of the film, which as a consequences must be replaced or at least covered, thus resulting in undesirable costs for the end users.

In addition, the Applicant surprisingly found that the flexible film according to the present invention shows improved resistance to stain and an increased ease of cleaning, when compared to films made from hydrogenated thermoplastic polyurethane (H-TPU) polymers.

In a second aspect, the present invention relates to an article selected from an interior or an exterior part of a motor vehicle, said article comprising at least one layer consisting of the flexible film according to the present invention.

In order to provide the advantages of the flexible film according to the present invention, said at least one layer is the outermost layer of said article, i.e. the layer exposed to the touch.

Then, in a third aspect, the present invention relates to a method for the manufacture of the flexible film as defined above, said method comprising:

(I) providing composition C as disclosed above;

(II) processing said composition C, so as to provide the flexible film according to the present invention.

### DESCRIPTION OF EMBODIMENTS

For the purposes of the present description:
the term “(per)fluoropolyether” is intended to indicate a “fully or partially fluorinated polyether”;
the expression “(per)fluoropolyoxyalkylene chain” is intended to indicate a partially or fully fluorinated, straight or branched, polyoxyalkylene chain;
the expression “flexible film” is intended to indicate a continuous layer, preferably in the form of a sheet, capable of bending without breaking;
the use of parentheses before and after symbols or numbers identifying compounds, chemical formulae or parts of formulae has the mere purpose of better distinguishing those symbols or numbers from the rest of the text and hence said parentheses can also be omitted.

Preferably, the flexible film according to the present invention is provided in the form of a flexible sheet.

Preferably, said flexible film comprises, more preferably consists of, one single layer, said layer being obtained from composition C as defined above.

Preferably, the flexible film according to the present invention has a thickness of from 0.1 to 5 mm, more preferably from 0.5 to 1 mm.

Preferably, the F-TPU polymer is a block copolymer, i.e. a polymer comprising blocks (also referred to as “segments”), each block comprising recurring units deriving from monomer (a), monomer (b), monomer (c) or monomer (d), as defined above.

Preferably, said F-TPU polymer has an average number molecular weight of from 30,000 to about 70,000 Da.

Preferably, said F-TPU polymer has a melting point (Tₘ) of from about 120° C. to about 240° C.

According to a preferred embodiment, said at least one monomer (a) is present in said F-TPU polymer.

Preferably, said at least one monomer (a) is different from said at least one monomer (d). More preferably, said at least one monomer (a) is selected from polyether type diol, polyester type diol, polybutadien-diol and polycarbonate-diol, wherein each of the poly-ether, poly-ester, polybutadien- and polycarbonate-moiety comprises more than 14 carbon atoms.

More preferably, the average number molecular weight of said at least one monomer (a) is from 500 to 4,000 Da, more preferably of from 1,000 to 4,000 Da.

More preferably, said at least one monomer (a) is selected in the group comprising poly(ethylene)glycol, poly(propylene)glycol, poly(tetramethylen)glycol (PTMG), poly(1,4-butanediol)adipate, poly(ethandiol-1,4-butanedio) adipate, poly(1,6-hexandiol-neopentyl)glycol adipate, poly-caprolactone-diol (PCL) and polycarbonate-diol. Poly(tetramethylen)glycol, poly-caprolactone-diol and polycarbonate-diol being particularly preferred.

Preferably, said at least one monomer (b) is a hydroxy-terminated (per)fluoropolyether polymer [PFPE polymer], i.e. a polymer comprising a (per)fluoropolyoxyalkylene chain [chain (R_{pf})] having two chain ends, wherein one or both chain ends terminates with at least one —OH group.

Preferably, at least one chain end of said chain (R_{pf}) terminates with a group of formula:

—CH₂(OCH₂CH₂)ₜ—OH (I)

wherein

t is 0 or from 1 to 5; more preferably, t is an integer higher than 1 and up to 5, even more preferably t is from 2 to 5.

More preferably, both chain ends of said chain (R_{pf}) terminate with a group of formula (I) as defined above.

Preferably, said chain (R_{pf}) is a chain of formula

—O-D-(CFX#)_{z1}—O(R_{f})(CFX*)_{z2}-D*-O—

wherein

z1 and z2, equal or different from each other, are equal to or higher than 1;

X# and X*, equal or different from each other, are —F or —CF3, provided that when z1 and/or z2 are higher than 1, X# and X* are —F;

D and D*, equal or different from each other, are an alkylene chain comprising from 1 to 6 and even more preferably from 1 to 3 carbon atoms, said alkyl chain being optionally substituted with at least one perfluoroalkyl group comprising from 1 to 3 carbon atoms;

(R_{f}) comprises, preferably consists of, repeating units R°, said repeating units being independently selected from the group consisting of:

(i) —CFXO—, wherein X is F or CF₃;

(ii) —CFXCFXO—, wherein X, equal or different at each occurrence, is F or CF₃, with the proviso that at least one of X is —F;

(iii) —CF₂CF₂CW₂O—, wherein each of W, equal or different from each other, are F, Cl, H;

(iv) —CF₂CF₂CF₂CF₂O—;

(v) —(CF₂)ⱼ—CFZ—O— wherein j is an integer from 0 to 3 and Z is a group of general formula —O—-R_{(f-a)}-T, wherein R_{(f-a)} is a fluoropolyoxyalkylene chain comprising a number of repeating units from 0 to 10, said recurring units being chosen among the following: —CFXO—, —CF₂CFXO—, —CF₂CF₂CF₂O—, —CF₂CF₂CF₂CF₂O—, with each of each of X being independently F or CF₃ and T being a C₁-C₃ perfluoroalkyl group.

More preferably, chain (R_{f}) is selected from the following formulae (R_{f}-a) to (R_{f}-c):

(R_{f}-a) -(CF₂O)ₙ(CF₂CF₂O)ₘ(CF₂CF₂CF₂O)ₚ(CF₂CF₂CF₂CF₂O)_{q}—wherein m, n, p, q are 0 or integers selected in such a way as chain R_{f} meets the above number average molecular weight requirement, with the proviso that if, p and q are simultaneously 0, n is not 0; when m is other than 0, the m/n ratio is preferably between 0.1 and 20; when (m+n) is other than 0, (p+q)/(m+n) is preferably between 0 and 0.2;

(R_{f}-b) —(CF₂CF(CF₃)O)ₐ(CF₂CF₂O)_{b}(CF₂O)_{c}(CF(CF₃)O)_{d}—

wherein a, b, c, d are 0 or integers selected in such a way as chain R_{f} meets the above number average molecular weight requirement; with the proviso that, at least one of a, c and d is not 0; when b is other than 0, a/b is preferably between 0.1 and 10; when (a+b) is different from 0 (c+d)/(a+b) preferably is between 0.01 and 0.5, more preferably between 0.01 and 0.2;

(R_{f}-c) —(CF₂CF(CF₃)O)ₑ(CF₂O)_{f}(CF(CF₃)O)_{g}—

wherein e, f, g are 0 or integers selected in such a way as chain R_{f} meets the above number average molecular weight requirement; when e is other than 0, (f+g)/e is preferably between 0.01 and 0.5, more preferably between 0.01 and 0.2.

PFPE polymers wherein chain (R_{f}) complies with formula (R_{f}-a) as defined above, wherein p and q are 0, are particularly preferred in the present invention.

In a preferred embodiment, said PFPE polymer complies with the following formula (PFPE-I):

HO—(CH₂CH₂O)ₜ-CH₂-(R_{pf})-CH₂(OCH₂CH₂)ᵤ—OH (PFPE-I)

wherein

t and u are, each independently, 0 or from 1 to 5; more preferably, t and u are, each independently, an integer higher than 1 and up to 5, even more preferably t and u are, each independently, from 2 to 5; and R_{pf} is as defined above.

Preferably, said PFPE polymer has an average number molecular weight of from 400 to 10,000 Da, more preferably from 1,000 to 5,000.

In a preferred embodiment, the molar ratio between monomers (a) when present and monomers (b) is from 2 to 20, more preferably from 2 to 10.

In a preferred embodiment, the amount of monomers (b) is such that the F-TPU polymer comprises from 4 to 80 wt. % of fluorine.

In a preferred embodiment, the amount of polymer (b) is such that the F-TPU polymer comprises from 2 to 50 wt. % of said monomer (b) based on the total weight of the F-TPU polymer; even more preferably from 2 to 25 wt. % and still more preferably from 2 to 10 wt. %.

Preferably, said at least one monomer (c) has a number molecular weight of 500 Da or lower, preferably from 10 to 500 Da.

Preferably, said at least one monomer (c) is selected in the group comprising, preferably consisting of, 4,4′-methylene-diphenylene-di-isocyanate (MDI), 1,6-hexan-diisocyanate (HDI), 2,4-toluene-diisocyanate, 2,6-toluene-diisocyanate, xylilen-diisocyanate, naphthalene-diisocyanate, paraphenylen-diisocyanate, hexamaethylen-diisocyanate, isophorone-diisocyanate, 4,4′-dicyclohexyl-methane-diisocyanate and cyclohexyl-1,4-diisocyanate.

MDI and HDI being particularly preferred.

Preferably, said at least one monomer (d) is selected in the group comprising, preferably consisting of, ethylene-glycol, 1,4-butanediol (BDO), 1,6-hexane diol (HDO), N,N-diethanolamine and N,N-diisopropanolaniline. BDO and HDO being particularly preferred.

In a preferred embodiment, the sum of blocks deriving from monomers (c) and (d) is from 10 to 60 wt. % based on the total weight of the F-TPU polymer.

Those skilled in the art would readily understand that blocks comprising recurring units derived from monomers (a) and (b) are rubber-like blocks, while blocks comprising recurring units derived from monomers (c) and (d) are hard blocks.

In a preferred embodiment, at least 80% of the blocks comprising recurring units derived from said monomers (b) [blocks B] are linked, at least one of their ends, to a block comprising recurring units derived from monomers (a) [blocks A] through a block comprising recurring units derived from monomers (c) [blocks C].

In other words, at least 80% of blocks B are contained in a sequence of the following type: -[A-C-B-C]-.

Advantageously, the F-TPU polymer can be prepared following the procedures disclosed in U.S. Pat. No. 5,332,798 (AUSIMONT S.P.A.).

According to a preferred embodiment, said composition (C) is free of plasticizer agents.

Optionally, composition (C) can comprise further ingredients, which are preferably selected from the group comprising: solvents, antioxidants, thermal stabilizers, dyestuffs, pigments and fillers.

Preferably, said solvent is selected in the group comprising polar aprotic solvents, such as N-methyl-pyrrolidone (NMP), dimethyl acetamide (DMAc), dimethylformamide (DMF), dimethylsulfoxide (DMSO), tetrahydrofuran (THF), methyl-5-dimethylamino-2-methyl-5-oxopentanoate (commercially available under the tradename Rhodialsov Polarclean®) and triethylphosphate (TEP).

Composition (C) according to the present invention can be provided in the form of a liquid composition [composition (C^{L})] or in the form of a solid composition [composition (C^{S})].

As used within the present description, the term “composition (C)” is intended to comprise both composition (C^{L}) and composition (C^{S}), unless otherwise indicated.

Preferably, said composition (C^{L}) comprises at least one F-TPU polymer in an amount of from 4 to 100 wt. %, more preferably from 10 to 70 wt. % and even more preferably from 15 to 60 wt. % based on the total weight of said composition (C^{L}).

Optionally, said composition (C^{L}) comprises at least one solvent in an amount of from 0.1 to 96 wt. %, more preferably from 30 to 90 wt. % and even more preferably from 40 to 85 wt. % based on the total weight of said composition (C^{L}).

Optionally, said composition (C^{L}) comprises at least one further ingredient as defined above in an amount of from 0.01 to 15 wt. % based on the total weight of said composition (C^{L}).

Said at least one further ingredient is preferably selected from those listed above with respect to composition (C).

Preferably, said composition (C^{S}) comprises at least one F-TPU polymer in an amount of from 50 to 100 wt. % based on the total weight of said composition (C^{S}).

Optionally, said composition (C^{S}) comprises at least one further ingredient as defined above in an amount of from 0.1 to 50 wt. % based on the total weight of said composition (C^{S}).

Said at least one further ingredient is preferably selected from those listed above with respect to composition (C).

The skilled person can properly select the amount of the F-TPU polymer and of the optional additives in composition (C), depending on the process to be performed.

According to a first embodiment, step (II) comprises the following steps:

(II-ia) manufacturing the flexible film and

(II-ib) applying the flexible film thus obtained, onto at least one surface of an article.

According to a second embodiment, step (II) comprises the following steps: (II-iib) manufacturing the flexible film directly onto at least one surface of an article.

Step (II-ia) and step (II-ib) can be performed according to methods known in the art, preferably by rotational moulding such as for example slush moulding, spray, vacuum forming and positive or negative thermoforming. Slush moulding, spray and thermoforming are particularly preferred.

According to a preferred embodiment, said step (II-ia) and step (II-ib) are performed by slush moulding.

Preferably, slush moulding comprises the following steps:

(i*) introducing composition (C^{S}) according to the present invention into a mould tool, wherein said mould tool comprises at least a portion made from a metal, preferably stainless steel or nickel;

(ii*) heating the mould tool until composition (C^{S}) forms a layer onto at least one portion of said mould tool;

(iii*) cooling the mould; and

(iv*) removing the article from the mould tool.

The mould tool preferably has a textured surface, so as to provide a textured article.

According to another embodiment, said step (II-ia) and step (II-ib) are performed by spray.

The spray process is preferably performed in a closed mold.

Preferably, the spray process comprises the following steps:

(i**) spraying composition (C^{L}) to the interior walls of a mould;

(ii**) contacting a polyurethane or polyurea filling composition with composition (C^{L}) into the mould;

(iii**) closing the mould; and

(iv**) curing said composition (C^{L}) and said filling composition.

Preferably, said step (i**) is performed such that composition (C^{L}) forms a layer having a thickness of at least 0.3 mm, more preferably from 0.5 to 5 mm onto the walls of the mould.

Preferably, said step (ii**) is performed by injecting, casting or spraying said filling composition.

According to a another embodiment, said step (II-ia) and step (II-ib) are performed by thermoforming.

Preferably, thermoforming comprises the following steps:

(i***) providing a mould;

(ii***) filling said mould with composition (C^{L});

(iii***) sealing the mould;

(iv***) heat treating the sealed mould; and

(v***) extracting the film from the mould.

Preferably, step (iv***) comprises two steps, i.e. a first step of heating at a first temperature for a time from 10 seconds to 10 minutes and a second step of heating at a second temperature, said second temperature being lower than said first temperature, for a time of from 30 seconds to 24 hours.

More preferably, said first temperature is from 120° C. to 300° C.

More preferably, said second temperature is from 50° C. to 200° C.

Alternatively, step (iv***) comprises only one step of heating at a temperature of from 50° C. to 300° C. for a time of from 10 seconds to 24 hours.

Preferably, after step (iv***) and before step (v***), the mould is allowed to cool down.

Preferably, said interior part of a motor vehicle is selected in the group consisting of instrument panel, dashboard, airbag covering, gear knob, tambour door, door handle, pedal covers, cable plugs, door trim and armrest.

Dashboards and instrument panels comprising at least one layer consisting of the flexible film according to the present invention are embodiments particularly preferred of the present invention.

Preferably, said exterior part of a motor vehicle is selected in the group consisting of bumpers, side panels, radiator grill seals, bonnet liner.

It will be apparent to the skilled person that the shape and the dimensions of the moulds are not limitative and can be properly selected depending on the desired shape and dimension of the final article to be prepared.

Should the disclosure of any patents, patent applications, and publications which are incorporated herein by reference conflict with the description of the present application to the extent that it may render a term unclear, the present description shall take precedence.

The invention will be herein after illustrated in greater detail by means of the Examples contained in the following Experimental Section; the Examples are merely illustrative and are by no means to be interpreted as limiting the scope of the invention.

### Experimental Section

Materials
Monomers (a):

(a1) CAPA™ 2201 (from Perstorp): polycaprolactone-diol (PLC) having molecular weight (Mw) of about 2,000 and —OH value of about 56 mg KOH/g;

(a2) polytetramethyleneglycol (PTMEG) having Mw of about 2,000

(a3) ETERNACOLL® UH200 (from UBE): polycarbonate-diol (PCD) having Mw of about 2,000

(a4) BESTER™ (from DOW) polyester-diol having Mw of about 2,000
Monomers (b) having formula:

H(OCH₂CH₂)ₚOCH₂CF₂O(CF₂CF₂O)ₘ(CF₂O)ₙCF₂CH₂O(CH₂CH₂O)ₚH

(b1) p=4.7 and Mw of about 2,000

(b2) p=1.6 and Mw of about 1,700
Monomers (c):

(c1) diphenylen-4,4′-diisocyanate (MDI)

(c2) 1,6-hexan-diisocyanate (HDI)
Monomers (d):

(d1) 1,4-butanediol (BDO)

(d2) 1,6-hexandiol (HDO)
Catalyst:

bismuth neodecanoate

Preparation of F-TPU Polymer Specimens—Method A

F-TPU polymer specimens 1 to 4 in the form of film were prepared starting from the abovementioned monomers following the same procedure detailed in Example 15 of U.S. Pat. No. 5,332,798 (to Ausimont S.p.A.) cited above.

F-TPU polymers thus obtained contained 20 wt. % of recurring units derived from monomers (b).

Preparation of F-TPU Polymer Specimens—Method B

F-TPU polymer specimens 5 to 8 in the form of film were prepared as follows:
the hydrogenated pre-polymer was synthetized by reacting monomer (c) and monomer (a) in the equivalent ratio 2 to 1, at a temperature of 90° C.;
the fluorinated pre-polymer was synthetized by reacting monomer (c) and monomer (b) in the equivalent ratio 2 to 1, at a temperature of 90° C.;
the hydrogenated pre-polymer and the fluorinated pre-polymer were then mixed together and stirred at 90° C. for 30 minutes;
monomer (c) was further added depending on the selected stoichiometry;
the reaction was continued at 90° C. for 3 minutes until chain-extension was completed;
the polymer thus obtained was casted at 100° C. for 24 hours.

The compositions of the F-TPU polymers obtained following methods A and B described above and the compositions of comparative hydrogenated polyurethane polymers (H-TPU) are reported in the following Table 1.

As further comparison, a commercially available hydrogenated TPU (H-TPU 9*) was used. The monomers ratio for H-TPU 9* is not publicly available.

TABLE 1

| | Monomers (molar ratio) | | | | | | | | | |
|---|---|---|---|---|---|---|---|---|---|---|
| | a1 | a2 | a3 | a4 | b1 | b2 | c1 | c2 | d1 | d2 |
| F-TPU 1 | 0.8 | — | — | — | 0.2 | — | 2.0 | — | 1.0 | — |
| F-TPU 2 | — | 0.7 | — | — | 0.3 | — | 3.0 | — | 2.0 | — |
| F-TPU 3 | — | 0.6 | — | — | — | 0.4 | 2.5 | — | 1.5 | — |
| F-TPU 4 | — | — | — | 0.75 | 0.25 | — | — | 2.0 | — | 1.0 |
| F-TPU 5 | 0.75 | — | — | — | — | 0.25 | — | 3.0 | 2.0 | — |
| F-TPU 6 | — | — | 0.75 | — | — | 0.25 | — | 2.0 | 1.0 | — |
| F-TPU 7 | 4.0 | — | — | — | — | 0.3 | — | 0.7 | 3.0 | — |
| H-TPU 8(*) | — | 1.0 | — | — | — | — | 2.0 | — | 1.0 | — |
| H-TPU 9(*) | n/a | — | — | — | — | — | — | n/a | n/a | — |

(*)comparison
n/a = value not available

The mechanical properties of the films made from F-TPU and H-TPU polymers were evaluated and the results are reported in Table 2.

TABLE 2

| | | Tensile strength | Elongation at |
|---|---|---|---|
| | Shore A | (MPa) | break (%) |
| F-TPU 1 | 85 | 28.1 | 471 |
| F-TPU 2 | 93 | 31 | 410 |
| F-TPU 3 | 80 | 35 | 400 |
| F-TPU 4 | 75 | 7.30 | 590 |
| F-TPU 5 | 90 | 26.1 | 505 |
| F-TPU 6 | 83 | 13 | 550 |
| F-TPU 7 | 91 | 31.8 | 506 |
| H-TPU 8(*) | 78 | 40 | 550 |

(*)comparison

The above results show that the F-TPU polymers according to the present invention have mechanical properties comparable with the mechanical properties of H-TPU polymers typically used in the production of flexible films (or skin materials) for coating parts of motor vehicles, and hence F-TPU polymers provide good mechanical properties to the flexible film of the invention.

The films were used in the Examples described hereinafter.

### EXAMPLE 1

### Contact Angle

This test is considered to be predictive for both stain and chemical resistance.

The static contact angle (SCA) of a sessile drop (about 5 μL) of water and n-hexadecane as solvents was measured with the DSA30 instrument (Krüss GmbH, Germany). The SCA values as well as standard deviations were calculated among ten contact angles.

Surface free energy (SFE) was calculated following the Owens, Wendt, Rabel and Kaelble method (WORK method), which is a standard method for calculating the surface free energy of a solid from the contact angle with several liquids.

The results are summarized in the following Table 3.

TABLE 3

| Sample | SCA H₂O | SCA C₁₆ | SFE (mN/m) |
|---|---|---|---|
| F-TPU 1 | 104 | 64.5 | 16.1 |
| F-TPU 2 | 110.5 | 63.6 | 15.09 |
| F-TPU 3 | 106.7 | 62.9 | 15.90 |
| F-TPU 4 | 86 | 61 | 23.6 |
| F-TPU 5 | 105 | 68 | 14.9 |
| F-TPU 6 | 103 | 66 | 16 |
| F-TPU 7 | 98 | 70 | 16.9 |
| H-TPU 8(*) | 77 | 46 | 30.93 |
| H-TPU 9(*) | 81 | 29 | 31.7 |

(*)comparison
SCA = Static Contact Angle
H₂O = water
C₁₆ = hexadecane
SFE = Surface Free Energy

The above results show that the contact angle measured with both water (H₂O) and hexadecane (C₁₆) increased while the surface energy dropped down to the range from 15 to 16 mN/m compared to 31 mN/m for the hydrogenated thermoplastic polyurethane used as reference compound. These data are consistent with an increase in terms of stain resistance and chemical resistance conferred by the F-TPUs compared to H-TPU.

### EXAMPLE 2

### Blue Denim Test

This test is considered to be predictive for both staining and abrasion resistance.

The test was performed with the instrument Taber Industries 5750 Linear Abraser, that was set to run at the following conditions:
cycle speed: 30 cycles/min
stroke length: 2.54 cm (1 inch)
number of cycles: 200
total load: 1 kg.

Tests were performed once with dry denim and once with wet denim on F-TPU 1, F-TPU 2, F-TPU 3, F-TPU 5 and F-TPU 7.

Before performing the test with wet denim, denim was submerged in water for 10 second, then it was removed and water was squeezed out by hand so that denim did not drip but was wet to the touch.

The tests were performed as follows: a denim sample measuring approximately 30 mm×30 mm was fixed to a fixture in order to prevent shifting of the sample during the test. A sample of each F-TPU and of H-TPU was then placed on the denim sample and fixed to the fixture as well.

Checkpoints were set as follows:
after rub and
after cleaning with isopropyl-alcohol (IPA).

Results for the dry test: no stain was observed for F-TPU 1, F-TPU 2, F-TPU 3, F-TPU 5 and F-TPU 7.

Results for the wet test: a very light halo was observed for F-TPU 1, F-TPU 2, F-TPU 3, F-TPU 5 and F-TPU 7.

### EXAMPLE 3

### Stain Test

A drop of each staining agent listed above was put into contact with the surface of a specimen made from F-TPU 1 and let for 24 hours at ambient conditions. The specimen was then cleaned with water.

A specimen made from H-TPU was used as comparison and treated as disclosed above.

The results are summarized in the following Table 4, wherein:

++=no stain

+=mark/halo

−=stain

TABLE 4

| Staining agent | H-TPU(*) | F-TPU 1 |
|---|---|---|
| Olive oil | − | ++ |
| Ketchup | + | ++ |
| Hot coffee | − | + |
| Mayonaise | − | ++ |
| Coca Cola | − | ++ |
| Mustard | − | + |
| Vinager | ++ | ++ |
| Windex ® cleaner | + | + |
| Formula 409 ® cleaner | + | + |
| Purell ® hand sanitizer | − | ++ |
| Vaseline intensive care lotion | − | ++ |
| Alcohol | − | ++ |

(*)comparison

The above results clearly showed the increase in term of both stain and chemical resistance of the F-TPU specimen compared to the H-TPU specimen.

### EXAMPLE 4

### Evaluation of Haptic Properties

The haptic properties (notably the feeling of softness) of F-TPUs and the H-TPUs were measured by testing the films of the materials subjectively by hand feel of 5 individuals.

Soft feel was measured subjectively by hand touch and rated on a scale from 1 to 5, with 1 being poor soft feel (hard feel) and 5 being excellent soft feel. Participants took part in this study individually, so they did not influence each other in their responses. Participants were presented with the four samples in a random order and asked to feel and rate them.

The results are summarized in the following Table 5.

TABLE 5

| | Rating | | | | | |
|---|---|---|---|---|---|---|
| | Individ- | Individ- | Individ- | Individ- | Individ- | |
| Sample | ual 1 | ual 2 | ual 3 | ual 4 | ual 5 | Average |
| F-TPU 1 | 4 | 5 | 4 | 4 | 5 | 4.4 |
| F-TPU 2 | 5 | 5 | 5 | 4 | 5 | 4.8 |
| F-TPU 3 | 5 | 4 | 4 | 4 | 4 | 4.2 |
| F-TPU 4 | 5 | 5 | 5 | 4 | 5 | 4.8 |
| F-TPU 5 | 5 | 4 | 4 | 3 | 4 | 4.0 |
| F-TPU 6 | 5 | 4 | 5 | 4 | 4 | 4.4 |
| F-TPU 7 | 4 | 4 | 4 | 4 | 5 | 4.2 |
| H-TPU 8(*) | 2 | 1 | 1 | 1 | 2 | 1.4 |
| H-TPU 9(*) | 2 | 2 | 1 | 1 | 2 | 1.6 |

(*)comparison

The above results clearly showed that the films obtained with the F-TPUs according to the present invention showed better haptic properties, notably improved feeling of softness, when compared to films obtained from H-TPU polymers.

1. A flexible film obtained from a composition [composition (C)] comprising at least one fluorinated polyurethane [F-TPU polymer] and optionally further ingredients, said F-TPU polymer comprising recurring units derived from:
optionally monomer (a), wherein monomer (a) is at least one diol selected from the group consisting of poly-ether type diols, poly-ester type diols, polybutadien-diols and polycarbonate-diols;
monomer (b), wherein monomer (b) is at least one hydroxy-terminated (per)fluoropolyether polymer;
monomer (c), wherein monomer (c) is at least one aromatic, aliphatic or cycloaliphatic diisocyanate; and
monomer (d), wherein monomer (d) is at least one aliphatic, cycloaliphatic or aromatic diol having from 1 to 14 carbon atoms.

2. The flexible film according to claim 1, wherein said at least one monomer (a) is present and selected from the group consisting of poly(ethylene)glycol, poly(propylene)glycol, poly(tetramethylen)glycol (PTMG), poly(1,4-butanediol)adipate, poly(ethandiol-1,4-butanedio) adipate, poly(l,6-hexandiol-neopentyl)glycol adipate, poly-caprolactone-diol (PCL) and polycarbonate-diol.

3. The flexible film according to claim 1, wherein said at least one monomer (b) is a polymer comprising a (per)fluoropolyoxyalkylene chain [chain (R_{pf})] having two chain ends, wherein one or both chain ends terminates with at least one —OH group.

4. The flexible film according to claim 3, wherein at least one chain end of said chain (R_{pf}) terminates with a group of formula:
—CH₂(OCH₂CH₂)ₜ—OH (I)
wherein
t is 0 or from 1 to 5.

5. The flexible film according to claim 4, wherein both chain ends of said chain (R_{pf}) terminate with a group of formula:
—CH₂(OCH₂CH₂)ₜ—OH (I)
wherein
t is 0 or from 1 to 5.

6. The flexible film according to claim 1, wherein said at least one monomer (c) is selected from the group consisting of 4,4′-methylene-diphenylene-di-isocyanate (MDI), 1,6-hexan-diisocyanate (HDI), 2,4-toluene-diisocyanate, 2,6-toluene-diisocyanate, xylilen-diisocyanate, naphthalene-diisocyanate, paraphenylen-diisocyanate, hexamaethylen-diisocyanate, isophorone-diisocyanate, 4,4′-dicyclohexyl-methane-diisocyanate and cyclohexyl-1,4-diisocyanate.

7. The flexible film according to claim 1, wherein said at least one monomer (d) is selected from the group consisting of ethylene-glycol, 1,4-butanediol (BDO), 1,6-hexane diol (HDO), N,N-diethanolamine and N,N-diisopropanolaniline.

8. A process for the manufacture of the flexible film as defined in claim 1, said method comprising:
(I) providing a composition (C), wherein composition (C) comprises at least one fluorinated polyurethane [F-TPU polymer] and optionally further ingredients, said F-TPU polymer comprising recurring units derived from:
optionally monomer (a), wherein monomer (a) is at least one diol selected from the group consisting of poly-ether type diols, poly-ester type diols, polybutadien-diols and polycarbonate-diols;
monomer (b), wherein monomer (b) is at least one hydroxy-terminated (per)fluoropolyether polymer;
monomer (c), wherein monomer (c) is at least one aromatic, aliphatic or cycloaliphatic diisocyanate; and
monomer (d), wherein monomer (d) is at least one aliphatic, cycloaliphatic or aromatic diol having from 1 to 14 carbon atoms; and
(II) processing said composition (C), so as to provide the flexible film.

9. The process according to claim 8, wherein said step (II) comprises:
(II-ia) manufacturing the flexible film and
(II-ib) applying the flexible film onto at least one surface of an article.

10. The process according to claim 8, wherein said step (II) comprises:
(II-iib) manufacturing the flexible film directly onto at least one surface of an article.

11. An article selected from an interior or an exterior part of a motor vehicle, said article comprising at least one layer consisting of the flexible film as defined in claim 1.

12. The article according to claim 11, wherein said interior part of a motor vehicle is selected from the group consisting of instrument panels, dashboards, airbag coverings, gear knobs, tambour doors, door handles, pedal covers, cable plugs, door trims and armrests.

13. The article according to claim 11, wherein said exterior part of a motor vehicle is selected from the group consisting of bumpers, side panels, radiator grill seals, and bonnet liners.

14. A dashboard comprising at least one layer consisting of the flexible film as defined in claim 1.

15. An instrument panel comprising at least one layer consisting of the flexible film as defined in claim 1.

16. The flexible film according to claim 1, wherein:
said at least one monomer (a) is present and selected from the group consisting of poly(ethylene)glycol, poly(propylene)glycol, poly(tetramethylen)glycol (PTMG), poly(1,4-butanediol)adipate, poly(ethandiol-1,4-butanedio) adipate, poly(1,6-hexandiol-neopentyl)glycol adipate, poly-caprolactone-diol (PCL) and polycarbonate-diol;
said at least one monomer (b) is a polymer comprising a (per)fluoropolyoxyalkylene chain [chain (R_{pf})] having two chain ends, wherein one or both chain ends terminates with at least one -OH group;
said at least one monomer (c) is selected from the group consisting of 4,4′-methylene-diphenylene-di-isocyanate (MDI), 1,6-hexan-diisocyanate (HDI), 2,4-toluene-diisocyanate, 2,6-toluene-diisocyanate, xylilen-diisocyanate, naphthalene-diisocyanate, paraphenylen-diisocyanate, hexamaethylen-diisocyanate, isophorone-diisocyanate, 4,4′-dicyclohexyl-methane-diisocyanate and cyclohexyl-1,4-diisocyanate; and
said at least one monomer (d) is selected from the group consisting of ethylene-glycol, 1,4-butanediol (BDO), 1,6-hexane diol (HDO), N,N-diethanolamine and N,N-diisopropanolaniline.

17. The flexible film according to claim 16, wherein at least one chain end of said chain (R_{pf}) terminates with a group of formula:
—CH₂(OCH₂CH₂)ₜ—OH (I)
wherein
t is 0 or from 1 to 5.

18. The flexible film according to claim 17, wherein both chain ends of said chain (R_{pf}) terminate with a group of formula:
CH₂(OCH₂CH₂)ₜ—OH (I)
wherein
t is 0 or from 1 to 5.

19. An article selected from an interior or an exterior part of a motor vehicle, said article comprising at least one layer consisting of the flexible film as defined in claim 16.
